(19) United States
(12) Patent Application Publication
(10) Pub. No.: US 2024/0196943 A1
(43) Pub. Date: Jun. 20, 2024

(54) METHOD AND SYSTEM FOR PROCESSING SEED KERNELS IN FOOD APPLICATIONS

(71) Applicant: Green Creamery, LLC, New York, NY (US)

(72) Inventor: Caitlin Jamison, Minneapolis, MN (US)

(73) Assignee: Green Creamery, LLC, New York, NY (US)

(21) Appl. No.: 18/538,330

(22) Filed: Dec. 13, 2023

Related U.S. Application Data
(60) Provisional application No. 63/387,194, filed on Dec. 13, 2022.

(51) Int. Cl. A23L 11/00; A23L 11/10; A23L 11/30

(52) U.S. Cl. CPC A23L 11/01; A23L 11/10; A23L 11/33

(57) ABSTRACT

A method of preparing a non-roasted nut, seed, grain, or legume base. The method includes cooking a feedstock comprising shelled nuts, shelled seeds, grains, or hulled legumes at a temperature, a pressure, a water-to-feedstock ratio, and for a time wherein at least a portion of chlorogenic acid present in the feedstock remains intact and activity of one or more enzymes present in the feedstock is substantially reduced or eliminated.

### CROSS-REFERENCE TO RELATED APPLICATIONS

Priority is hereby claimed to provisional application Ser. No. 63/387,194, filed Dec. 13, 2022, which is incorporated herein by reference.

### BACKGROUND

There is a growing need for food products that address several pressing issues, including long-term sustainability, nutrition and health concerns, allergies in consumers, and other dietary restrictions. Food allergies currently impact one out of every four consumers. The U.S. Centers for Disease Control & Prevention reports that the overall prevalence of food allergies increased by 50 percent between 1997 and 2011. Peanut and tree nut allergies tripled in U.S. children between 1997 and 2008. According to Food Allergy Research & Education (“FARE”), 32 million Americans have food allergies, 5.6 million of whom are children. Based on the current population of the U.S., that equates to 1 out of every 13 children. On average in the U.S., an allergic reaction caused by food sends someone to the emergency room every three minutes. Medical procedures to treat food-induced anaphylaxis increased by 380% between 2007 and 2016. More than 40% of children with food allergies and more than 50% of adults with food allergies have experienced a severe and potentially life-threatening allergic reaction. See, for example, “Food Allergy Research & Education. Facts and Statistics,” www.foodallergy.org/resources/facts-and-statistics, retrieved 12/11/2023 (hereinafter “FARE 2022”).

More than 6 million Americans suffer from severe milk allergies. Thus, milk allergies are as prevalent as shellfish and peanut allergies. For this demographic, dairy alternatives are not a trend, but a necessity. Milk is the third most common food—after peanuts and tree nuts—to cause anaphylaxis. (FARE 2022.) In addition to life-threatening allergies, 68% of the entire world's population suffer from lactose malabsorption. See, for example, the National Institute of Diabetes and Digestive and Kidney Diseases, at www.niddk.nih.gov/health-information/digestive-diseases/lactose-intolerance/definition-facts#:˜:text=While%20most%20infants%20can%20digest,world%27s%20population%20has, accessed Dec. 11, 2023 (hereinafter “NIDDK 2018”). Many people who don't even have allergies or intolerances make a concerted effort to avoid dairy for health concerns around saturated fat, cholesterol, artificial growth hormones, and antibiotics. Another subset of the population avoids dairy because of the environmental and ethical concerns intrinsic to factory farming and livestock breeding.

While many dairy alternatives currently exist, very few of them minimize the concentration of other common allergens. Most commercially available, dairy-free cheeses, yogurts, milks, butters, etc. use tree nuts, coconuts, soy, and/or sesame in their formulations. This makes these products unacceptable for those who suffer from allergies to those substances. Legumes, including peas, have been utilized in recent years, but there is a growing concern about cross-reactions for those with peanut allergies. See Taylor et al. (2021) “A perspective on pea allergy and pea allergens,” Trends in Food Science & Technology, 116: 186-198.

In the realm of allergen-free, dairy-free products, other types of substitutes have become popular, including oat-based milks, yogurts, and butters. However, these products are also low in protein and naturally high in carbohydrates and sugars. Enzymatic treatment of the complex starches in oats also increases the simple sugar content of these products.

Sunflower seed allergies are relatively rare. See Ukleja-Sokołowska, et al. (2016), “Sunflower seed allergy,” International journal of immunopathology and pharmacology, 29(3):498-503. In addition to a very low risk for allergic reactions, sunflower seeds offer a nutritious and sustainable food source material.

### SUMMARY

Disclosed herein is a method of processing seed kernels, such as sunflower seed kernels, and other seeds, nuts, grains, and legumes, for a variety of food applications. The method preserves the inherent benefits and attributes of sunflower seed kernels (or other nut, seed, grain, or legume feedstock), while avoiding certain reactions that may arise when using conventional processing techniques.

Thus, disclosed herein is a method of preparing a non-roasted nut, seed, grain, or legume base (e.g., sunflower seeds). the method comprising cooking a feedstock comprising shelled nuts, shelled seeds, grains, or hulled legumes at a temperature of from about 180° F. to about 270° F., a pressure of from about 8 psi to about 15 psi (about 55 KPa to about 103 KPa), a water-to-feedstock ratio of from 1:1 to about 6:1 (by weight), and a time of from about 5 minutes to about 75 minutes, wherein at least a portion of chlorogenic acid present in the feedstock remains intact and activity of one or more enzymes selected from the group consisting of amylases, proteases, and polyphenol oxidase is substantially reduced or eliminated.

This method is easily scalable from batches of less than 1 kg to batches greater than 1000 kilograms. It can be incorporated into in-line processes as well as batch processes, thus allowing for its incorporation into processes of various scale and applications.

The method can be used to process, for example, seeds, nuts, grains, and legumes. The method can be performed on the whole kernel, ground material, or expeller-pressed meal that is a by-product of oil seed processing. For sake of brevity only, sunflower seeds will be used as an example feedstock. When used on sunflower seed kernels, the method yields a “sunflower seed mass base,” as described herein. The sunflower seed mass base can be used as a starting material for unique dairy-alternative products. When used with the appropriate feedstock, the method yields a high quality, plant-based material that is free from the top 14 recognized allergens. The method and the resulting product fill a long felt and unmet need for plant-based products with reduced allergenicity that can be used as a base material for making dairy substitutes.

Disclosed is a novel method of preparing seed kernels, such as sunflower seed kernels, for use in dairy alternatives and other food applications. Applicable uses for this process include, but are not limited to (i) fermented and cultured dairy alternatives/analogues/substitutes such as non-dairy yogurt, kefir, cheeses, butters, lassi, and the like); liquid non-fermented dairy alternatives (fluid non-dairy milk alternatives, creamers, smoothies, and the like); acid-curdled/coagulated dairy alternatives (curd-type non-dairy cheeses, dips, spreads, butters and the like); thickened dairy alternative products (puddings, desserts, pie fillings, frozen novelty bases, and the like); frozen dairy alternative products (soft-serve frozen dessert base, frozen yogurt base, frozen ice cream alternatives, bars and confections, and the like); confectionery fillings and toppings (icings, glazes, fillings, frosting, candies, caramels, non-dairy chocolates, compound coatings, and the like); baking applications (cakes, cookies, breads, and the like); doughs for pasta, pie shells, empanadas, crackers, and the like; extrusions for the production of snacks and cereals, and the like; egg-replacement products and applications and the like; dressings, vegan mayonnaise alternatives, savory spreads, and the like.

The method yields a non-roasted seed, nut, or legume base, such as a sunflower seed base (also may be referred to as a “seed mass base” or a “sunflower seed mass base”) wherein the native enzymes in the seed kernel have been inactivated. The native enzymes in seeds such as sunflower seeds include, but are not limited to amylases, proteases, and polyphenol oxidase (PPO).

Methods disclosed herein also allow for the reduction of aflatoxins, mycotoxins, pathogens, yeasts, molds, and spoilage organisms that may be present on the sunflower kernel, and may be applicable to other seeds. The presence of these microbiological and chemical risk factors can limit the safety and shelf-life of foods with high water activity, including the aforementioned product applications.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 1 to 9, from 3.6 to 4.6, from 3.5 to 9.9, and so forth.

All references to singular characteristics or limitations of the present invention shall include the corresponding plural characteristic or limitation, and vice-versa, unless otherwise specified or clearly implied to the contrary by the context in which the reference is made. The indefinite articles “a” and “an” mean “one or more” unless explicitly stated to the contrary. The word “or” is used inclusively and should be read as “and/or.”

All combinations of method or process steps as used herein can be performed in any order, unless otherwise specified or clearly implied to the contrary by the context in which the referenced combination is made.

The methods of the present invention can comprise, consist of, or consist essentially of the essential elements and limitations of the method described herein, as well as any additional or optional ingredients, components, or limitations described herein or otherwise useful in food chemistry.

The enzymatic inactivation occurs via heat contact in moist conditions with a rapid temperature increase due to pressure. This can be achieved for sunflower seeds using, for example:
i. A closed, sealed vessel where sunflower seed kernels, water, and accompanying materials are heated with pressure applied. Temperatures achieved may be as high as 132° C. (270° F.) and pressure may exceed 12 psi.
ii. Steam injection into a closed system to rapidly increase temperature and inactivate the enzymes.
iii. An autoclave system that combines steam and high pressure.
iv. An extrusion system with high heat and steam injection.
v. Jet-cooking systems.
vi. Scraped-surface heat exchanger systems.
vii. Reaction vessels that include, but are not limited to cookers with increased surface area with heat-exchanging plates, scraped surface, a heated jacket, and pressure.

### DETAILED DESCRIPTION

In accordance with the present disclosure, an advantage of treating the sunflower seeds, nuts, grains, and legumes as disclosed herein can be expected to result in enzyme denaturation. Denaturation of endogenous enzymes modifies color, organoleptic attributes, and reduces the anti-nutritive properties of the seeds, nuts, grains, and legumes.

Sunflower seeds contain endogenous enzymes. Some enzyme levels are decreased when the exterior shells/hulls are removed. Further reduction in enzyme levels occurs during germination/sprouting.

In food processing, the activity of some enzymes can be deactivated by heat, pressure and chemical processing. Heating via traditional boiling processes causes the seeds to remain in a temperature range where the endogenous enzymes are most active, from roughly about 30° C. to about 77° C. (99° F. to 170° F.) prior to their inactivation as the system gets up to temperature, which can result in a significant amount of enzyme activity prior to reaching the point of enzyme denaturation.

In the case of sunflower seeds, this is due to the nature of the fibrous-waxy exterior of the sunflower kernel and the density of the interior mass as compared to the tissues of fruits and vegetables, which respond more favorably to blanching.

Without the addition of external acidification, boiling sunflower seeds produces an optimal pH system for enzyme activity (pH 5.5 to 6.0). The following enzymes are of particular concern:

Amylase Enzyme: Amylase enzymes break down starches. If the native amylase in a sunflower kernel is not properly inactivated prior to use in food formulations, there is a risk that the amylase will break down the starches in the system. This has been observed in a sunflower-based dairy alternative that was thickened with tapioca starch. Due to the presence of amylase, the system became more liquid over time; decreasing its shelf-life and adversely impacting the product quality.

There are three types of amylases (alpha, beta, gamma) and each is inactivated at a different temperature range. Exceeding 82° C. (180° F.) will denature both alpha and beta amylase. The inactivation of alpha amylase using pressure combined with heat has been demonstrated in fruit applications. Riahi, et al. (2004), “High pressure inactivation kinetics of amylase in apple juice,” Journal of Food Engineering, 64(2):151-160.

Polyphenol Oxidase (PPO) Enzyme: Polyphenol oxidase (PPO) is responsible for the formation of discoloration as the tissues of fruits and vegetables upon exposure to oxygen. This includes browning on the surface of apples and graying on potatoes. In sunflower seeds, PPO reacts with chlorogenic acid present in seeds and nuts and can form green-to-gray colors, depending on the pH of the system.

The native pH of sunflower seeds is close to neutral and may border on alkaline depending on the mineral content. As a result, when sunflower seeds are heated using conventional methods, the seeds rupture and release native chlorogenic acid (“CGA”) into the reaction solution. The CGA then reacts with PPO to form undesirable gray to green pigments.

Studies on PPO in other matrices indicated temperatures of from 45° C. to 55° C. (113°-131° F.) increased PPO activity by as much as 65%. See Buckow, et al. (2004), “High pressure inactivation kinetics of amylase in apple juice,” Journal of Food Engineering, 64(2):151-160. PPO from sunflower seeds has been shown to be most active at temperatures ranging from 55° to 60° C. (131° F. to 140° F.). Singh, et al. (1999), “Studies of the physico-chemical properties and polyphenoloxidase activity in seeds from hybrid sunflower (Helianthus annuus) varieties grown in India,” Food Chemistry, 66(2):241-247.

Inactivation of the PPO enzyme prevents the formation of gray, brown, and olive-green pigments that can cause undesirable appearance, taste, and aroma profiles in later processing.

Even when the seeds are added to water that is boiling (as in a blanching process), the time it takes for the interior to the kernel to exceed enzyme inactivation temperature results in the formation of gray-green substances. These gray-green colors also form during traditional grinding processes because the heat generated during the grinding fosters enzyme activity and oxidation. This is why raw sunflower butters tend to have a gray color.

It is a particular goal of the present method to preserve undegraded at least a portion of the naturally occurring CGA in the incoming feed stock, while minimizing the activity of the PPO (and other enzymes). CGA is of nutritional interest as a bioactive compound. CGA's systematic name is (1S,3R,4R,5R)-3-{[(2E)-3-(3,4-dihydroxyphenyl)prop-2-enoyl]oxy}-1,4,5-trihydroxycyclohexane-1-carboxylic acid, and has the structure:

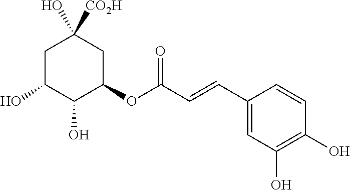 [SMILES: O=C(/C=C/c1ccc(O)c(O)c1)O[C@@H]1C[C@](O)(C(=O)O)C[C@@H](O)[C@H]1O]

It is an ester of caffeic acid and (−)-quinic acid. Research indicates that it may have prebiotic functions, particularly for Lactobacillus and Bifidobacterium species, which are used in yogurt products.

Prior art methods of improving the color of sunflower seed derived proteins and ingredients have focused on removing the CGA from the system. See, for example, Zhang et al. (2019) “Preparation of high-quality sunflower seed protein with a new chlorogenic acid hydrolase from Aspergillus niger,” Biotechnol Lett, 41(4-5):565-574, which eliminates the beneficial functional role that CGA contributes to a food system. In contrast, the method disclosed herein inactivates the activity of PPO while retaining at least a portion of the CGA. This yields a sunflower seed mass base with a desirable white to off-white color.

Anti-Nutritive Enzymes: Anti-nutritive enzymes are inactivated by heat, thereby making the nutrients in the sunflower seeds more bioavailable and preventing those enzymes from causing digestive issues including gas and bloating. Sunflower seeds contain several types of trypsin inhibitors, which are a class of anti-nutritive enzymes.

Softening Kernels for Subsequent Processing: Softening nuts, seeds, grains, and other starting materials by soaking with water at varying temperatures and with various additives is one technique that is utilized in the dairy alternatives industry. This can be a risk when the starting materials carry a high microbial load, as is the case with raw sunflower kernels. The native enzymes and polyphenolic compounds in sunflower seed kernels may also start to react in the presence of added water, resulting in the formation of additional pigment compounds.

Adding amylase, protease, and cellulase enzymes has also been utilized to improve the mouthfeel and texture of dairy alternatives. However, this can result in a change to the nutritional properties of the finished products. Typical sunflower seed products are made via the grinding action of metal blades or stone wheels. As mentioned previously, this process fosters reactions involving PPO. In addition, moisture present in sunflower seeds can result in the development of an emulsion during the grinding process. This can cause equipment to seize due to the high viscosity of the emulsion. Typical nut and seed butters are made with roasted nuts or sunflower seeds to reduce the moisture content, or by adding oil to improve flow of the system. Though roasted profiles are desirable in certain applications, they are not always suitable for all applications in terms of taste, color, and aroma.

Reduction of the Microbial Load and Pathogen Elimination: Raw sunflower seed kernels may carry CFU counts as high as 100,000,000 CFU per gram. Pathogens, including Salmonella spp. and Escherichia coli are a potential risk due to cross-contamination and the neutral pH of the system. Via treatment with heat and pressure, vegetative microorganisms present are destroyed, including pathogens. Yeasts and molds are also destroyed in the conditions described herein. Moisture combined with high temperatures is effective for destroying spores, such as Bacillus subtilis. However, some spores may require temperatures as high as 130° C. (266° F.). In conditions where Clostridium sp. are of concern, a combination of pH reduction acidification and a longer pressure-cooking process are recommended. When additional ingredients are to be added to the processed sunflower mass, it is recommended that the final blended mass be pasteurized prior to packaging. Aflatoxins are derived from mold growth during the storage of grains and seeds and may be present in sunflower seeds. Mmongoyo et al. (2017) “Aflatoxin levels in sunflower seeds and cakes collected from micro- and small-scale sunflower oil processors in Tanzania,” PLOS ONE 12(4): e0175801. Aflatoxins and similar mycotoxins are significantly decreased in the presence of high heat and pressure.

Maintain Inherent Ingredients: If the water used in the pressure-cooking process is utilized with the processed seed mass, all of the native compounds in the sunflower kernel are still present. This includes the minerals, oils, sugars, and lecithin. The sunflower lecithin acts as a natural emulsifier and helps prevent fat separation in subsequent dairy alternative preparations. This reduces the need for the use of external emulsifiers in many applications.

Nutrition: There is some concern that the use of extreme heat may degrade heat-labile nutrients such as Vitamin C and amino acids. As noted in traditional dairy processing, time and temperature as a combination are factors in the degradation of nutrients, as noted by the use high-temperature pasteurization processes as compared to vat pasteurization processes. If the water used in the processing of the sunflower seed mass is removed in subsequent steps, the subsequent nutritional profile of the sunflower seed mass would be impacted because water-soluble nutrients would be present in the aqueous phase of the system. If the fibrous exterior portion of the kernel is also not utilized in food preparations, the fiber content as well as some of the other nutrients present in the sunflower mass would be impacted. The inactivation of the anti-nutritive enzymes as well as the preservation of the chlorogenic acid also helps to improve the overall nutrition of the finished sunflower seed mass base.

Clean Label: Consumers have become increasingly wary of processed foods and as a result, the demand for “minimally” processed foods has grown substantially. In addition, organic food regulations prohibit the use of certain solvents and extraction methodologies. Traditional means of liberating the “meats” of sunflower kernels relied on solvent-based extraction methods. Furman, et al. (1959), “Direct extraction of sunflower seed by filtration-extraction,” J Am Oil Chem Soc, 36:454-457. Because the current method does not introduce additional chemicals, microorganisms or enzymes into the process, it aligns with the “kitchen” level of processing that consumers find acceptable.

Nutritional Compositions: The present disclosure includes nutritional compositions. Such compositions include any food or preparation for human consumption (including for enteral or parenteral consumption) which when taken into the body (a) serve to nourish or build up tissues or supply energy and/or (b) maintain, restore, or support adequate nutritional status or metabolic function.

The nutritional composition comprises at least one nut, seed, grain, or legume mass material made as described herein and may either be in a solid, semi-solid or liquid form. Additionally, the composition may include added edible macronutrients, vitamins and minerals in amounts desired for a particular use. The amount of such ingredients will vary depending on whether the composition is intended for use with normal, healthy infants, children or adults having specialized needs.

With respect to vitamins and minerals, the following may be added to the nutritional compositions described herein: calcium, phosphorus, potassium, sodium, chloride, magnesium, manganese, iron, copper, zinc, selenium, iodine, and Vitamins A, E, D, C, and the B complex. Other such vitamins and minerals may also be added.

Examples of nutritional compositions disclosed herein include but are not limited to infant formulas, dietary supplements, dietary substitutes, and rehydration compositions.

The nutritional composition of the present invention may also be added to food even when supplementation of the diet is not required. For example, the composition may be added to food of any type including but not limited to margarines, modified butters, cheeses, milk, yoghurt, chocolate, candy, snacks, salad oils, cooking oils, cooking fats, meats, fish, and beverages.

### Examples

The sunflower seed kernels are removed from the hulls using conventional protocols by the sunflower seed processor. The kernels are then sorted to remove any external debris and foreign matter, as well as the “sticktights” and fragments of the exterior hull. When using whole kernels, they are also rinsed using filtered water prior to processing. The kernels can also be rinsed with a dilute organic acid solution to further reduce the microbial load of the kernels and prevent enzymatic reactions. The rinsed kernels are then added to a pressure cooking vessel with water. The water-to-seed ratio is preferably from about 1:1 to about 6:1 (by weight). Additional reagents may also be introduced at this point. For example, salt may be added to soften protein fractions and to increase the boiling point of the water.

On or more organic acids may also be added to the cooking vessel. The use of organic acids, such as acetic, lactic acid, gluconic acid, or citric acid can be used to depress the pH of the system. This tends to improve the color of the finished product by preventing enzymatic reactions in the early stages of the cooking process. Chelating agents may also be added to the cook. Materials that aid with chelation, including (but not limited to) citric acid, EDTA, ethylenediamine, dimercaprol and gluconates, inhibit iron, copper, and other materials naturally present in the seed from participating in oxidation reactions. Any chelating agent deemed “generally regarded as safe” by the U.S. Food and Drug Administration may be used.

The pressure-cooking process requires a minimum amount of water to operate. While using amounts of water above and below the stated range is explicitly within the scope of the present disclosure, it is preferred that a minimum water-to-seed ratio of about 1:1 (by weight) is used. The process requires greater energy input when larger amounts of water are used.

Preferred pressures for the cooking are from about 8 psi to about 15 psi (about 55 KPa to about 103 KPa). This allows temperatures to reach upwards of 250° F. quickly. The quick temperature rise eliminates the time that the seeds spend at optimal enzyme activity temperatures. Pressures above and below this range are included.

The cooking time is preferably as short as about 5 minutes to as long as about 75 minutes, or any increment therebetween. Cooking times shorter and longer are included. However, using cooking times outside the stated range have a noted impact on the texture, flavor, and functional properties of the product. Because some nutrients are heat-labile, shorter cooking times within the stated range are generally preferred.

The heating element within the cooking vessel should be designed to avoid scalding and burn-on. This is important for maintaining a neutral-tasting base product with optimal color and appearance. This is a serious consideration for practical scale-up of this process because surface-area-to-sunflower-mass ratios change. Starting the process with culinary steam and/or boiling water as opposed to ambient water prior to applying pressure can also help reduce the cooking time and negative events such as scalding. Stirred or agitated cookers are generally preferred.

After the pressure-cooking step is completed, the seeds have gone from a light gray color to a white-beige color. The exterior fibrous layer of the kernel is also separated from the interior portion of the kernel. The processed mass can be used as is, directly from the cooker. Alternatively, further processing may also be included. The initial processed mass is high in fiber. To achieve certain desired organoleptic properties, such as smoothness, the fibrous materials can be mechanically removed (by conventional means such as filtration) to achieve a smooth texture. The mass, with or without the fiber removed, may also be treated with cellulase enzymes after the cooking step is completed.

Additional steps, including maceration, decanting, centrifugation, and fermentation processes may also be employed on the processed seed mass. Thus, for example, cultures can be added to the mass to ferment it to yield a non-dairy yogurt, kefir, cheese, and the like.

Acids may be added to the mass, post-cooking. The acid can be added in an amount sufficient to cause curdling of at least a portion of the proteins contained in the mass. This yields cheese-like products.

Coagulants such as nigiri may also be added to the processed mass. This yields to form a tofu-like composition of matter.

Sweeteners, salts, herbs, spices, starches, pectins, gums, fats, and hydrocolloids can be utilized to yield different food and beverage products that meet a variety of criteria.

The sunflower seed mass base remains a white to cream color over time. This indicates that the bulk of enzyme activity in the mass has been inactivated. The aroma and taste of the processed mass is mild.

The processed seed mass base can be immediately utilized in downstream food applications. It can also be refrigerated or frozen (as desired) for subsequent applications. For example, the processed seed mass can be used to prepare plant-based dairy analogues with reduced allergenicity. It can be used as a food additive and modifier to improve color and texture. The processed mass also improves food safety by minimizing antigens/contaminants in the mass.

What is claimed is:

1. A method of preparing a non-roasted nut, seed, grain, or legume base, the method comprising cooking a feedstock comprising shelled nuts, shelled seeds, grains, or hulled legumes at a temperature, a pressure, a water-to-feedstock ratio, and for a time wherein at least a portion of chlorogenic acid present in the feedstock remains intact and activity of one or more enzymes selected from the group consisting of amylases, proteases, and polyphenol oxidase is substantially reduced or eliminated.

2. The method of claim 1, wherein the feedstock is cooked at a temperature of from about 180° F. to about 270° F.

3. The method of claim 1, wherein the feedstock is cooked at a pressure of from about 8 psi to about 15 psi (about 55 KPa to about 103 KPa).

4. The method of claim 1, wherein the feedstock is cooked water-to-feedstock ratio of from about 1:1 to about 6:1 (by weight).

5. The method of claim 1, wherein the feedstock is cooked for a time of from about 5 minutes to about 75 minutes.

6. The method of claim 1, wherein the feedstock comprises sunflower seed kernels.

7. The method of claim 1, wherein the feedstock is cooked at a temperature of from about 180° F. to about 270° F., a pressure of from about 8 psi to about 15 psi (about 55 KPa to about 103 KPa), a water-to-feedstock ratio of from 1:1 to about 6:1 (by weight), and a time of from about 5 minutes to about 75 minutes.

8. The method of claim 7, wherein the feedstock comprises sunflower seed kernels.

9. A method of preparing a non-roasted sunflower seed base, the method comprising cooking a feedstock comprising sunflower kernels at a temperature of from about 180° F. to about 270° F., a pressure of from about 8 psi to about 15 psi (about 55 KPa to about 103 KPa), a water-to-feedstock ratio of from 1:1 to about 6:1 (by weight), and a time of from about 5 minutes to about 75 minutes, wherein at least a portion of chlorogenic acid present in the feedstock remains intact and activity of one or more enzymes selected from the group consisting of amylases, proteases, and polyphenol oxidase is substantially reduced or eliminated.

10. The method of claim 9, further comprising adding an edible, organic acid to the feedstock prior to cooking.

11. The method of claim 10, wherein the acid is selected from the group consisting of acetic acid, lactic acid, gluconic acid, and citric acid.

12. The method of claim 9, further comprising adding a chelating agent to the feedstock prior to cooking.

13. The method of claim 12, wherein the chelating agent is selected from the group consisting of citric acid, ehtylenediaminetetraacetic acid (EDTA), ehtylenediamine, dimercaprol, and gluconates.

14. An edible composition made according to the method of claim 1.
